(19) United States
(12) Patent Application Publication
(10) Pub. No.: US 2024/0145814 A1
(43) Pub. Date: May 2, 2024

(54) BATTERY UNIT

(71) Applicant: TOYOTA JIDOSHA KABUSHIKI KAISHA, Toyota-shi Aichi-ken (JP)

(72) Inventor: Koji Nakanishi, Konan-shi Aichi-ken (JP)

(73) Assignee: TOYOTA JIDOSHA KABUSHIKI KAISHA, Toyota-shi Aichi-ken (JP)

(21) Appl. No.: 18/379,695

(22) Filed: Oct. 13, 2023

(30) Foreign Application Priority Data
Oct. 28, 2022 (JP) 2022-173378

(51) Int. Cl. H01M 10/6551; H01M 10/613; H01M 10/647; H01M 50/209

(52) U.S. Cl. CPC H01M 10/6551; H01M 10/613; H01M 10/647; H01M 50/209

(57) ABSTRACT

A battery unit which achieves both thermal performance and repairability, and which efficiently ensures insulation between a battery cell and a cooler. The battery unit according to the present disclosure comprises a battery cell, a heat dissipation sheet, a cured resin heat dissipation member, and a cooler in this order so as to be in contact with each other, the battery cell and the heat dissipation sheet being in contact with each other in an interface separable manner, the cured resin heat dissipation member being bonded to the heat dissipation sheet and the cooler.

### CROSS-REFERENCE TO RELATED APPLICATION

This application claims priority to Japanese Patent Application No. 2022-173378 filed on Oct. 28, 2022, the entire contents of which are herein incorporated by reference.

### FIELD

The present disclosure relates to a battery unit comprising battery a cell and a cooler for cooling the battery cell.

### BACKGROUND

PLT 1 discloses a battery unit comprising a plurality of battery cells, a cooler, and a thermal conductive material. The plurality of battery cells are arranged in a predetermined stacking direction. The cooler has a refrigerant flow path through which a refrigerant that exchanges heat with the battery cells flows. The thermal conductive material is in the form of a gel and is provided between the battery cells and the cooler and is in close contact with the cooling surface of the cooler and the heat dissipating surface of the battery cells.

PLT 2 discloses a heat dissipation structure comprising a plurality of heat dissipation members and a connecting member which connects the plurality of heat dissipation members. The heat dissipation member comprises a plurality of cushion members and a thermal conductive sheet covering an outer surface of the cushion member. The connecting member comprises an insulating film and a pair of adhesive tapes. The insulating film is arranged between a heat source and the heat dissipation member in a state in which the plurality of heat dissipation members is arranged along a direction orthogonal to the longitudinal direction thereof. The pair of adhesive tapes respectively cover both surfaces of the insulating film in the thickness direction.

PLT 3 discloses a thermal conductive sheet comprising a first planar portion, a second planar portion, and a connecting portion. The thermal conductive sheet is deformed such that the first planar portion protrudes from the second planar portion toward the circuit board P. The surface of the first planar portion on the circuit board P side is bonded to a metal case. The surface of the second planar portion opposite to the circuit board P is bonded to an inner surface of a housing.

### CITATIONS LIST

### Patent Literature

[PTL 1] Japanese Patent Publication No. 2020-53148 A
[PLT 2] Japanese Patent Publication No. 2022-12195 A
[PLT 3] Japanese Patent Publication No. 2016-042582 A

### SUMMARY

### Technical Problem

The battery cell is cooled using a cooler which uses a refrigerant, and when the battery cell and the cooler directly contact with each other, a gap may be generated, and the thermal resistance may increase. Therefore, it is common to sandwich the flexible heat dissipation member between the battery cell and the cooler to transfer heat.

When a non-adhesive heat dissipation sheet is used as the heat dissipation member of the battery unit, the heat dissipation sheet is compressed and used, so that the heat dissipation sheet may be deformed and settling may occur (creep phenomenon). Further, since the heat dissipation sheet has no adhesion to the metal, when the heat dissipation sheet loses the reaction force due to the settling, a gap is generated at the interface between the heat dissipation sheet and the battery cell or at the interface between the heat dissipation sheet and the cooler, thereby the thermal performance deteriorates.

When an adhesive cured resin heat dissipation member is used as the heat dissipation member of the battery unit, the heat performance is easily ensured. However, it is difficult to disassemble parts for repair or the like. In other words, in this case, when the battery unit is disassembled, the film on the surface of the battery cell may be damaged or the coating on the case surface of the battery cell may be peeled off, so that the components cannot be easily replaced and the repairability is poor.

The present disclosure has been made in view of the above-described problems, and provides a battery unit which achieves both thermal performance and repairability, and which efficiently ensures insulation between a battery cell and a cooler.

### Solution to Problem

### Embodiment 1

A battery unit comprising a battery cell, a heat dissipation sheet, a cured resin heat dissipation member, and a cooler in this order so as to be in contact with each other,
the battery cell and the heat dissipation sheet being in contact with each other in an interface separable manner,
the cured resin heat dissipation member being bonded to the heat dissipation sheet and the cooler.

### Embodiment 2

The battery unit according to embodiment 1,
wherein the heat dissipation sheet is partially embedded in the cured resin heat dissipation member, and at least a part of a side surface of the heat dissipation sheet is restrained by the cured resin heat dissipation member.

### Embodiment 3

The battery unit according to embodiment 1 or 2 comprising a wall portion on a surface of the cooler and on a part or all of an outer periphery of the cured resin heat dissipation member.

### Embodiment 4

The battery unit according to embodiment 1 or 2,
wherein the thermal conductivity of the heat dissipation sheet is 0.8 W/m·K or more, and the Asker C hardness of the heat dissipation sheet is 0 or more.

### Effects of Present Disclosure

According to the present disclosure, it is possible to obtain a battery unit which achieves both thermal performance and repairability, and which efficiently ensures insulation between a battery cell and a cooler.

### BRIEF DESCRIPTION OF DRAWING

FIG. 1 is a schematic perspective view of the battery unit according to an embodiment of the present disclosure.

FIG. 2 is a schematic side cross-sectional view of the battery unit according to an embodiment of the present disclosure.

FIG. 3 is a schematic side sectional view of the battery unit according to another embodiment of the present disclosure.

FIG. 4A is a schematic side cross-sectional view illustrating a method of assembling the battery unit according to an embodiment of the present disclosure.

FIG. 4B is a schematic side cross-sectional view illustrating a step of a method of assembling the battery unit according to an embodiment of the present disclosure.

FIG. 4C is a schematic side cross-sectional view illustrating a step of a method of assembling the battery unit according to an embodiment of the present disclosure.

FIG. 4D is a schematic side cross-sectional view illustrating a step of a method of assembling the battery unit according to an embodiment of the present disclosure.

### DESCRIPTION OF EMBODIMENTS

The battery unit of the embodiment of the present disclosure may be a battery unit mounted in a vehicle such as a hybrid vehicle or an electric vehicle.

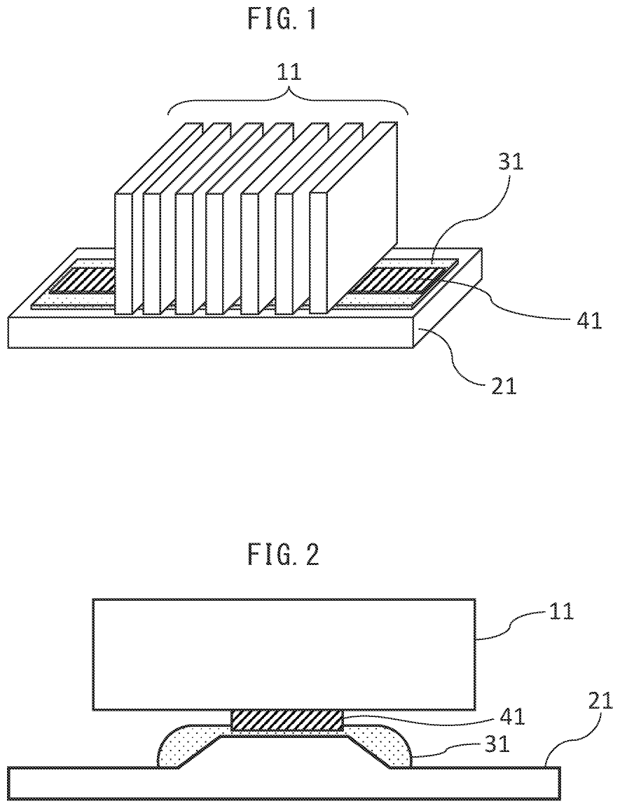

FIG. 1 is a schematic perspective sectional view of a battery unit according to an embodiment of the present disclosure. FIG. 2 is a schematic side cross-sectional view of a battery unit according to an embodiment of the present disclosure. Hereinafter, the battery unit according to the embodiment of the present disclosure shown in FIGS. 1 and 2 will be described in detail. The battery unit of the present disclosure is not limited to this embodiment.

The battery unit of the present embodiment comprises a battery cell 11, a heat dissipation sheet 41, a cured resin heat dissipation member 31, and a cooler 21 in this order so as to be in contact with each other. One or a plurality of battery cells 11 may be provided.

According to the battery unit of the present embodiment, heat generated during charging and discharging of the battery cell 11 is conducted from the bottom surface of the battery cell 11, in which the heat dissipation sheet 41 is in close contact, to the cooler 21 via the heat dissipation sheet 41 and the cured resin heat dissipation member 31. The heat conducted to the cooler 21 is absorbed by the cooling solvent flowing in the cooler 21. As a result, the battery cell 11 can be cooled.

In general, when a battery cell generates heat, the battery cell expands, and when the expanded battery cell is cooled (spontaneously cooled), the battery cell shrinks. Therefore, when only the heat dissipation sheet is used between the battery cell and the heat dissipation member, along with the expansion of the battery cell, the heat dissipation sheet in contact with the battery cell extends in the lateral direction, and deteriorates while being deformed, causing settling, and when the battery cell shrinks, a gap is formed between the heat dissipation sheet and the bottom surface of the battery cell, and the thermal performance may be deteriorated.

On the other hand, according to the present embodiment, since the heat dissipation sheet 41 is bonded to the cured resin heat dissipation member 31 and is restrained by the cured resin heat dissipation member 31, the heat dissipation sheet 41 is unlikely to settle, and therefore the thermal performance is prevented from being deteriorated.

(Battery Cell)

The battery cell is in contact with the heat dissipation sheet in an interface separable manner. The battery unit of the present disclosure may have one or a plurality of battery cells 11. When there is a plurality of battery cells 11, the plurality of battery cells 11 can constitute a battery module. The battery cell at both ends of the battery module may be sandwiched between a pair of end plates.

The battery cell 11 may be a secondary battery configured by accommodating a negative electrode layer, a positive electrode layer, a separator, and the like in a rectangular parallelepiped case. Examples of the secondary battery include a lithium-ion battery. The upper portion of the battery cell 11, the terminals of the positive and negative electrodes are provided. When there is a plurality of battery cells 11, a plurality of battery cells may be electrically connected by a bus bar.

(Heat Dissipation Sheet)

The heat dissipation sheet 41 is arranged between the battery cell 11 and the cured resin heat dissipation member 31 such that one surface is in contact with the battery cell and the other surface is in contact with the cured resin heat dissipation member 31. The heat dissipation sheet is in contact with the battery cell in an interface separable manner. Further, since the cured resin heat dissipation member is bonded to the heat dissipation sheet, the heat dissipation sheet is restrained by the cured resin heat dissipation member.

The heat dissipation sheet 41 has adhesiveness on the surface thereof and can be attached to the bottom surface of the battery cell 11. The heat dissipation sheet 41 may have elasticity and be freely deformable by a compressive load.

The material of the heat dissipation sheet 41 is not particularly limited. Examples of the material of the heat dissipation sheet 41 include cured resins of a heat curing type, a room temperature curing type, a moisture curing type, and an ultraviolet curing type. As a material of the heat dissipation sheet 41, a cured resin of one-liquid type or two-liquid mixture type may be used. Examples of such cured resins include silicone resins, epoxy resins, and urethane resins.

The heat dissipation sheet 41 may contain fillers in order to improve the thermal conductivity. As the fillers, an insulating inorganic compound may be used. Examples of the insulating inorganic compound include silicon compounds such as fused silica, metal oxides such as alumina and magnesia, and nitrogen compounds such as boron nitride and aluminum nitride.

The heat dissipation sheet 41 need not have a single structure. An adhesive layer having thermal conductivity may be formed on one or both surfaces of the heat dissipation sheet 41. In some embodiments, when the adhesive layer is formed only on one surface of the heat dissipation sheet 41, the surface on which the adhesive layer is formed is adhered to the bottom surface of the battery cell 11.

The heat dissipation sheet 41 may be partially embedded in the cured resin heat dissipation member 31. When the heat dissipation sheet 41 is embedded in the cured resin heat dissipation member 31, at least a part of the side surface of the heat dissipation sheet is restrained by the cured resin heat dissipation member 31. As a result, the heat dissipation sheet 41 is less likely to settle, and the thermal performance is prevented from deteriorating.

The heat dissipation sheet 41 has heat conductivity necessary for efficiently dissipating the heat of the battery cell 11 to the cooler 21 via the cured resin heat dissipation member 31. In some embodiments, the thermal conductivity of the heat dissipation sheet 41 is equal to or higher than 0.8 W/m·K as measured by the hot disk method.

In some embodiments, the hardness of the heat dissipation sheet 41 is 0 or more in the Asker C hardness measured by a durometer (Asker C type).

In some embodiments, the lower surface of the heat dissipation sheet 41 (the surface in contact with the cured resin heat dissipation member 31) is roughened. By roughening the lower surface, thermal performance is easily ensured.

In the present embodiment, a commercially available product may be used as the heat dissipation sheet 41. Examples thereof include a thermal interface silicone rubber sheet (Shin-Etsu Chemical Co., Ltd.: TC-00CAT-20) or Cool Provide (registered trademark) (Kitagawa Industries Co., Ltd.: CPVP).

Since the heat dissipation sheet 41 is in contact with the battery cell in an interface separable manner, it can be easily separated off from the battery cell 11 when the battery unit is disassembled. Therefore, an aspect of the present embodiment is in repairability and component recyclability.

(Cured Resin Heat Dissipation Member)

The cured resin heat dissipation member 31 is arranged between the heat dissipation sheet 41 and the cooler 21 and is bonded to the heat dissipation sheet 41 and the cooler 21. The cured resin heat dissipation member 31 is made of a material which is in a liquid state or a paste state when it is brought into contact with the cooler 21 and the heat dissipation sheet 41 at the time of manufacturing the battery unit of the present embodiment and is cured to be in a solid state after being brought into contact with the cooler 21 and the heat dissipation sheet 41.

The cured resin heat dissipation member 31 may be any of a heat curable type, a room temperature curable type, a moisture curable type, an ultraviolet curable type, and the like. The cured resin heat dissipation member 31 can have a curable property by having a curable resin. The curable resin which can be used as the material of the cured resin heat dissipation member 31 can be selected from a curable resin of a heat curable type, a room temperature curable type, a moisture curable type, or an ultraviolet curable type, in particular, a silicone resin, an epoxy resin, a urethane resin, and the like of a heat curable type, a room temperature curable type, a moisture curable type, or an ultraviolet curable type.

The material of the cured resin heat dissipation member 31 may be the same as the material of the heat dissipation sheet 41 described above. When the material of the cured resin heat dissipation member 31 and the material of the heat dissipation sheet 41 are the same, the adhesiveness at the interface between the cured resin heat dissipation member 31 and the heat dissipation sheet 41 is improved, which is advantageous in securing the thermal performance.

The cured resin heat dissipation member 31 may comprise fillers such as an insulating inorganic compound in addition to the curable resin in order to improve heat conduction. Examples of the insulating inorganic compound include silicon compounds such as fused silica, metal oxides such as alumina and magnesia, and nitrogen compounds such as boron nitride and aluminum nitride.

In some embodiments, the thermal conductivity of the cured resin heat dissipation member 31 is equal to or higher than 0.8 W/m·K as measured by the hot disk method. In addition, the cured resin heat dissipation member 31 is made of a material which has flexibility and is freely deformed by compression. In some embodiments, the hardness of the cured resin heat dissipation member 31 is 0 or more in the Asker C hardness measured by a durometer (Asker C type). In some embodiments, the cured resin heat dissipation member 31 has a viscosity of 500 Pa·s or less at a stage prior to being brought into contact with the cooler 21 and the heat dissipation sheet 41 and cured.

In the present embodiment, a commercially available product may be used as the cured resin heat dissipation member 31. Examples thereof include gap-fillers (DuPont: BETATECH2029), and potting materials (Shin-Etsu Chemical Co., Ltd.: KE-1895-A/B).

(Cooler)

The cooler 21 cools the battery cell 11. The cooler 21 may have a block shape and may be made of a metal such as aluminum. A refrigerant flow path through which a cooling solvent that exchanges heat with the battery cell 11 flows is formed inside the cooler 21, and the cooling solvent cooled to a predetermined temperature can flow through the refrigerant flow path. The cooling solvent is, for example, a cooling solvent of an in-vehicle air conditioner.

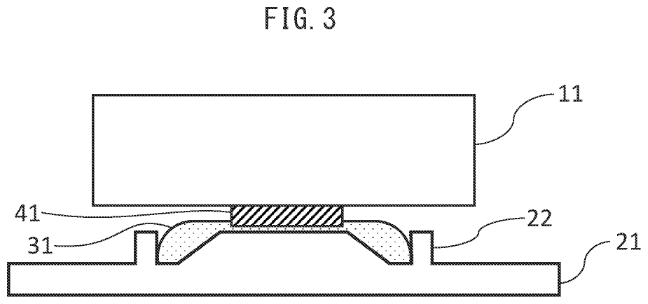

As shown in FIG. 3, the surface of the cooler 21 may include a wall portion (protrusion) 22 on a part or all of the outer periphery of the cured resin heat dissipation member 31. By having the wall portion 22 on the surface of the cooler 21, it is possible to prevent the liquid cured resin heat dissipation member 31 before curing from flowing out during assembly of a battery unit to be described later.

<Assembling Method of Battery Unit>

Next, a method of assembling the battery unit of the present embodiment will be described with reference to the drawings. First, the battery cell 11, the heat dissipation sheet 41, the cured resin heat dissipation member 31, and the cooler 21 are prepared.

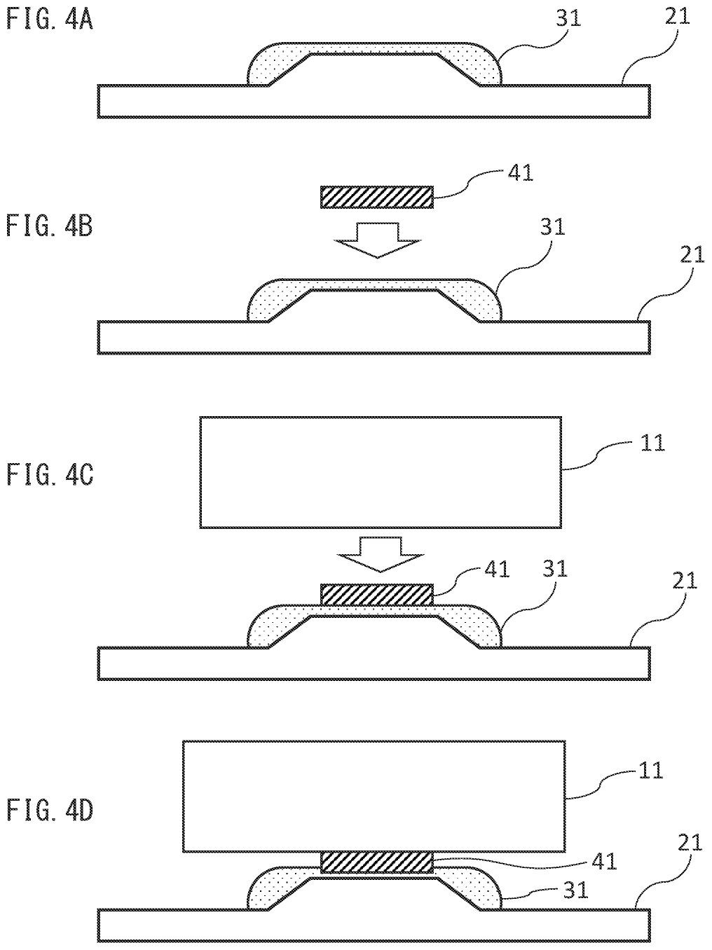

Next, the cured resin heat dissipation member 31 is applied onto the cooler using a nozzle (FIG. 4A).

The cured resin heat dissipation member 31 is in a liquid state or a paste state at the time of application. A wall portion may be provided on the cooler 21 to prevent the liquid or paste cured resin heat dissipation member 31 from flowing out before curing. The cured resin heat dissipation member 31 is applied so as to be larger than the projected area of the heat dissipation sheet. The thickness of the application can be selected according to the structure of the battery unit. For example, it may be about 2 to 10 mm.

Next, the heat dissipation sheet 41 is attached to the cured resin heat dissipation member (FIG. 4B), and the battery cell 11 is assembled thereon (FIG. 4C). Subsequently, the battery cell 11 is pressurized, or the heat dissipation sheet 41 is inserted into the cured resin heat dissipation member 31 by the weight of the battery cell 11 (FIG. 4D). Thus, after the cured resin heat dissipation member 31 is cured, the heat dissipation sheet 41 is restrained by the cured resin heat dissipation member 31. Subsequently, the cured resin heat dissipation member 31 is cured in a predetermined manner according to the type such as a heat-curing type, a room temperature curing type, a moisture-curing type, or an ultraviolet-curing type.

According to the above-described assembly method, the battery unit of the present embodiment in which the battery cell 11, the heat dissipation sheet 41, the cured resin heat dissipation member 31, and the cooler 21 are in close contact with each other can be manufactured. The one or more battery cells 11 and the cooler 21 may be fastened by using bolts and nuts.

In the battery unit of the present embodiment, the battery cell and the heat dissipation sheet are in contact with each other in an interface separable manner. Therefore, repairability and component recyclability are improved. Further, since the heat dissipation sheet 41 is bonded to the cured resin heat dissipation member 31, long-term reliability of the heat performance can be ensured. In other words, the thermal performance is improved. Further, since the cured resin heat dissipation member 31 restrains the heat dissipation sheet 41, the reaction force of the heat dissipation sheet does not decrease. Therefore, a fixing frame and a pressing member for preventing a decrease in the reaction force of the heat dissipation sheet are no longer necessary, and the number of parts and the number of steps can be reduced.

An embodiment of the present disclosure has been described in detail above. The present disclosure is not limited to the above-described embodiment, and various design changes can be made without departing from the mind of the present disclosure.

### REFERENCE SIGNS LIST

11 Battery cell
21 Cooler
22 Wall portion
31 Cured resin heat dissipation member
41 Heat dissipation sheet

1. A battery unit comprising a battery cell, a heat dissipation sheet, a cured resin heat dissipation member, and a cooler in this order so as to be in contact with each other,
wherein the battery cell and the heat dissipation sheet are in contact with each other in an interface separable manner, and
wherein the cured resin heat dissipation member is bonded to the heat dissipation sheet and the cooler.

2. The battery unit according to claim 1,
wherein the heat dissipation sheet is partially embedded in the cured resin heat dissipation member, and thereby at least a part of a side surface of the heat dissipation sheet is restrained by the cured resin heat dissipation member.

3. The battery unit according to claim 1, comprising a wall portion on a surface of the cooler and on a part or all of an outer periphery of the cured resin heat dissipation member.

4. The battery unit according to claim 1,
wherein the thermal conductivity of the heat dissipation sheet is 0.8 W/m·K or more, and
wherein the Asker C hardness of the heat dissipation sheet is 0 or more.
